(19) United States
(12) Patent Application Publication
(10) Pub. No.: US 2026/0099342 A1
(43) Pub. Date: Apr. 9, 2026

(54) GENERATIVE ARTIFICIAL INTELLIGENCE-BASED SYSTEM TO ASSIST IN THE COMPLETION OF A VIRTUAL PROCESS

(71) Applicant: INTUIT INC., Mountain View, CA (US)

(72) Inventors: Isham RAJGARIAH, Bengaluru (IN); Parmanand MOURYA, Bengaluru (IN); Ram YERUBANDI, Bengaluru (IN); Pradeep Kurunimakki LAXMINARAYANA, Bengaluru (IN); Sandeep MEWARA, Bengaluru (IN); Sanjay GUPTA, Bengaluru (IN); Sanjay KUMAR, Bengaluru (IN)

(21) Appl. No.: 18/909,231

(22) Filed: Oct. 8, 2024

(51) Int. Cl. G06F 9/448

(52) U.S. Cl. CPC G06F 9/448

(57) ABSTRACT

Aspects of the present disclosure relate to automatic virtual process completion assistance. Embodiments include receiving data associated with a given virtual process. Embodiments further include retrieving, based on a semantic similarity comparison involving the received data and embedding representations of a set of rules, one or more rules. Embodiments further include retrieving one or more knowledge graphs of a set of knowledge graphs based on the received data, wherein each respective knowledge graph of the set of knowledge graphs represents a respective historical virtual process instance. Embodiments further include providing an input based on the received data, the retrieved rules, and the retrieved knowledge graphs to a machine learning model that is configured to evaluate virtual processes. Embodiments further include generating, using the machine learning model, an evaluation of the given virtual process based on the received data, the retrieved rules, and the retrieved knowledge graphs.

### INTRODUCTION

Aspects of the present disclosure relate to techniques for automatically assisting in the completion of virtual processes. In particular, techniques described herein involve using knowledge graphs of historical virtual process instances and a set of rules contained in an embedding vector database to assist a generative machine learning model in generating a recommendation regarding an order for completing steps of the virtual process, generating an indication regarding a level of progress of a user in completing the virtual process, and/or the like.

### BACKGROUND

Every year millions of people, businesses, and organizations around the world utilize software applications to assist with performing virtual processes. Virtual processes may, for instance, refer to processes performed via computing applications. For example, software applications may be used to complete and process electronic forms, construct electronic datasets, develop and deploy changes to other software applications, and/or the like.

Completing virtual processes is often a complex and tedious process. As a result, it can be difficult to assess how close a user is to completing a virtual process, which can in turn make it difficult to assess the workload and performance of, for example, a team of workers that complete virtual processes. Additionally, when the performance and progress of a user cannot be accurately tracked, support interventions may not be provided to users who need assistance (or, support interventions may be provided to users who do not actually need assistance). Processor resources may be wasted in providing interventions that are not necessary, or in neglecting to provide interventions to users who need them.

Furthermore, due to the complexity of electronic processes, it can be difficult for users to determine what steps should be performed or addressed first in order to complete the process most efficiently. For example, a given member of a team that completes virtual processes may have a set of tasks to perform. The user may be able to perform the first task and the second task in the same amount of time. However, the first task may be related to additional tasks that may be performed by other users, and completing the additional tasks may not be possible until the first task is completed. Thus, to avoid a bottleneck in completing the virtual process, the user may need to complete the first task before the second task. In many cases, however, the complexity of virtual processes often makes determining an optimal sequence of step completion impractical to perform mentally. For example, virtual process completion may involve hundreds of users and thousands of steps. Thus, even experienced users may be unable to determine an optimal sequence of steps for completing a virtual process.

Additionally, existing computing technologies may be unable to calculate an optimal sequence of steps for completing virtual processes and/or determine the progress/workload of a user in completing virtual processes. For example, while conventional machine learning technologies excel at analyzing data and producing accurate predictions based on input features, data associated with virtual processes may be too complicated for such machine learning models to analyze, leading to inaccurate results. While training can improve the ability of machine learning models to analyze virtual process data, such training can require an extensive amount of time and resources. For instance, complex machine learning models can take several weeks to train. Additionally, trained machine learning models may require frequent updating or retraining to account for new data, new virtual processes, and/or the like, resulting in further time and resources being expended.

Thus, there is a need in the art for improved techniques of assisting in the completion of virtual processes.

### BRIEF SUMMARY

Certain embodiments provide a method of automatic virtual processes completion assistance. The method generally includes: receiving data associated with a given virtual process; retrieving, based on a semantic similarity comparison involving the received data and embedding representations of a set of rules, one or more rules of the set of rules; retrieving one or more knowledge graphs of a set of knowledge graphs based on the received data, wherein each respective knowledge graph of the set of knowledge graphs represents a respective historical virtual process instance; providing the received data, the retrieved rules, and the retrieved knowledge graphs as input to a machine learning model that is configured to evaluate virtual processes; and generating, using the machine learning model, an evaluation of the given virtual process based on the received data, the retrieved rules, and the retrieved knowledge graphs.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated virtual process completion assistance.

FIG. 2 depicts an additional example of computing components related to automated virtual process completion assistance.

FIG. 3 depicts an example of a knowledge graph according to certain embodiments.

FIG. 4 depicts example operations related to automated virtual process completion assistance.

FIG. 5 depicts an example of a processing system for automated virtual process completion assistance.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated virtual process completion assistance.

According to certain embodiments, a semantic similarity comparison may be performed based on data associated with a given virtual process to identify one or more rules that are relevant to the virtual process. One or more knowledge graphs that represent historical virtual process instances may be retrieved based on the data. The knowledge graphs may be converted into natural language descriptions of virtual process instances, for example, by using a graph query language to assemble a natural language prompt based on information within a knowledge graph. An input that is created based on the rules, the knowledge graphs, and the data may then be provided to a machine learning model that is configured to evaluate virtual processes. The machine learning model may then generate an evaluation of the given virtual process. For example, the evaluation may comprise a recommended order for completing steps of the given virtual process, an estimated level of completion (e.g., a completion percentage) of the virtual process, and/or the like.

Embodiments of the present disclosure provide numerous technical and practical effects and benefits. For example, techniques described herein allow for automatically identifying an optimal sequence of steps to complete in a virtual process. An optimal sequence may prevent bottlenecks that would otherwise occur in the completion of virtual processes, resulting in saved time and computing resources. Also, techniques described herein allow for automatically determining the level of progress that users have made in completing virtual processes. As a result, support interventions may be provided when necessary, and unnecessary support interventions may be avoided.

Furthermore, embodiments disclosed herein represent an improvement to machine learning technologies. For example, conventional machine learning techniques may be unable to accurately evaluate virtual processes due to the complexity of such virtual processes. However, techniques described herein allow for automatically retrieving particular types of highly relevant virtual process data and presenting this relevant data to a machine learning model in a format that the machine learning model can process in connection with evaluating the virtual process. Thus, embodiments of the present disclosure enable machine learning models to accurately evaluate virtual processes, such as in connection with generating optimal sequences of steps for completing the virtual processes and/or determining the level of progress that users have made in completing the virtual processes, without extensive training and fine tuning.

### Example of Computing Components Related to Automated Virtual Process Completion Assistance

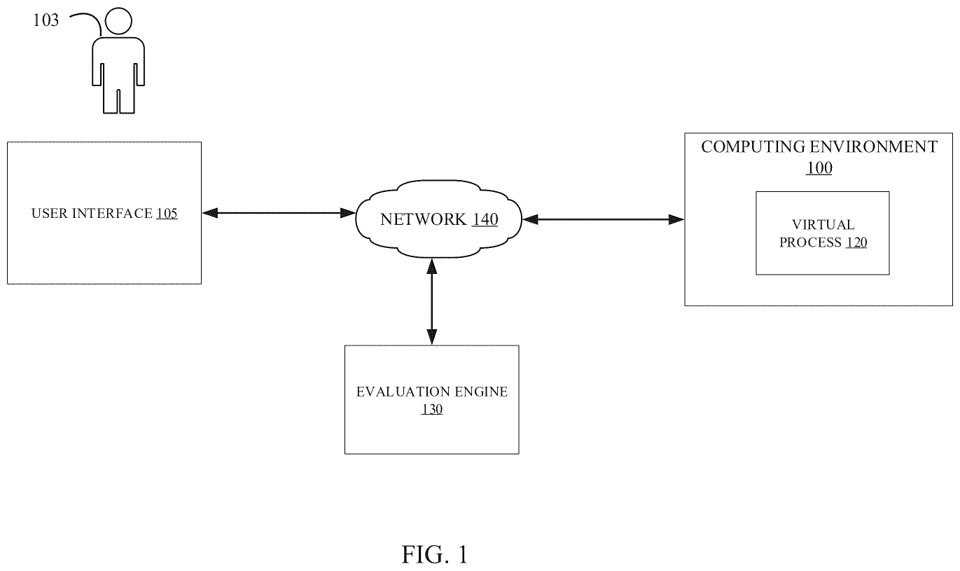

FIG. 1 depicts an example of computing components related to automated virtual process completion assistance.

A user 103 may interact with a computing environment 100 via a user interface 105 associated with a computing device. The computing environment 100 may, for example, comprise a software application. The computing environment 100 may be used to perform tasks related to a virtual process 120. The virtual process 120 may generally be any type of computing task that can be performed by one or more users of a software application. For example, the virtual process 120 may comprise development of computer code for a software application, and a team of programmers may use the computing environment 100 to complete the code. As another example, a virtual process 120 may comprise completing an electronic tax return form or another electronic document. The taxpayer may use the computing environment 100 to complete the form, or one or more tax professionals may use the computing environment 100 to complete the form.

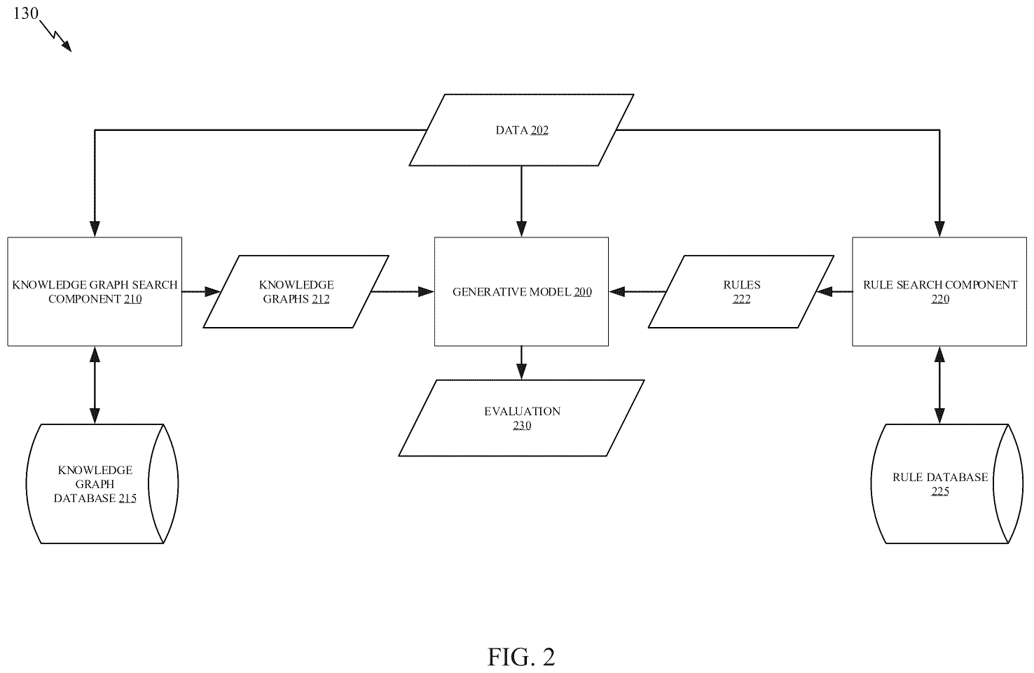

The software application associated with the user interface 105, the computing environment 100, and an evaluation engine 130 may interact over network 140. Network 140 may be any connection over which data may be transmitted. In one example, network 140 is the Internet. Data related to the virtual process 120 may be sent to the evaluation engine 130. As described in further detail below with respect to FIG. 2, the evaluation engine 130 may assist the user 103 in completing the virtual process 120 based on the data.

FIG. 2 depicts an additional example of computing components related to automated virtual process completion assistance. In particular, FIG. 2 depicts functionality that may be performed by the evaluation engine 130 of FIG. 1.

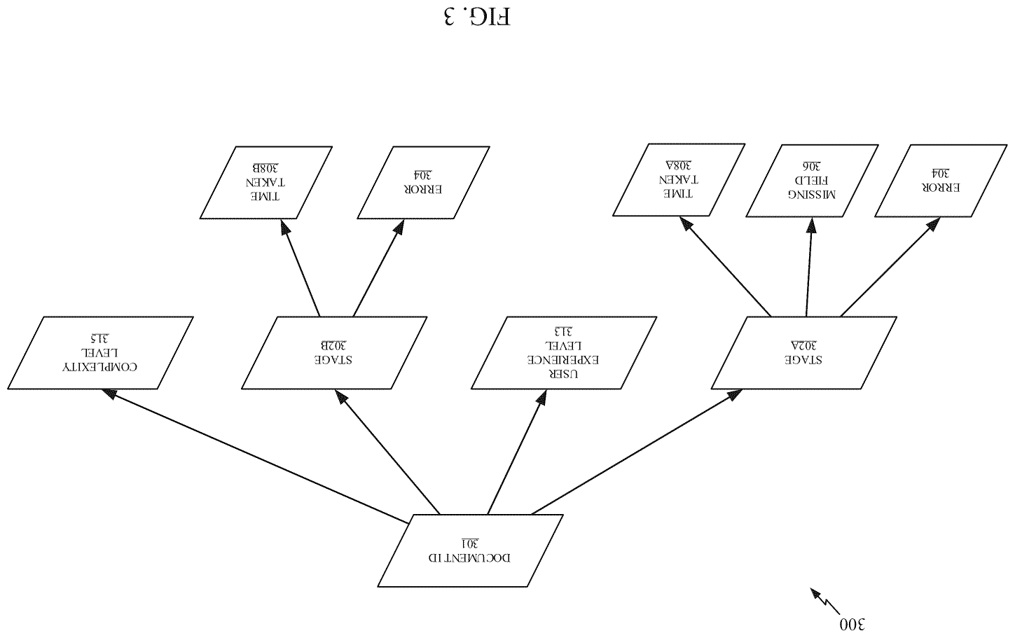

A knowledge graph database 215 may contain knowledge graphs that represent historical instances of virtual processes, as described in further detail below with respect to FIG. 3. For example, a knowledge graph may represent factors such as the state of a virtual process, time spent on the virtual process, errors present in the virtual process, incomplete tasks, and expertise of a user completing the virtual process. A second knowledge graph may represent the state of the same virtual process after the user spends a given amount of time working on the virtual process. Other knowledge graphs may provide similar representations of different virtual processes. For example, a first set of knowledge graphs may represent the progression of a user in completing a first virtual process, and a second set of knowledge graphs may represent the progression of a user in completing a second virtual process (e.g., the first virtual process may be an electronic tax form for a first individual, and the second virtual process may be an electronic tax form for a second individual). In some embodiments, the knowledge graphs are created automatically based on features of virtual processes. For example, an identifier associated with a virtual process may be automatically inserted into a node in a knowledge graph that stores identifiers, a numerical value representing time spent completing a virtual process may be inserted into a node that stores the time, and so on.

A rule database 225 may contain rules for virtual processes. In some embodiments, vector representations, such as embedding representations, of the rules may be created and stored in the rule database 225. An embedding generally refers to a vector representation of an entity that represents the entity as a vector in n-dimensional space such that similar entities are represented by vectors that are close to one another in the n-dimensional space. Embeddings may be generated using an embedding model in some embodiments. The embedding model may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Jena AI, Word2Vec, and GloVe embeddings. These are included as examples, and other techniques for generating vector representations of entities (such as embedding representations) are possible.

The rules may generally comprise any type of rule that can be used in evaluating a virtual process. For example, rules for evaluating the virtual process of software application development may involve checking whether all required functions and variables have been created, ensuring that every section of the application code has been updated to include changes made in one section, checking for errors, and/or the like. As another example, rules for the virtual process of electronic form completion may involve checking to see whether all required fields have been completed, checking whether all values are within a valid range, and/or the like. In some embodiments, the rules may further comprise rules for determining the complexity of the given virtual process. For example, a rule for software development may state that the complexity increases as the number of a particular type of function increases, while a rule for form completion may state that the complexity increases as the number of a particular type of field increases. For a tax return form, a rule may state that complexity increases as the number of employers of the filer increases. Also, different types of virtual processes may have different base complexities (e.g., the base complexity may be increased as the number of fields, functions, and/or the like increases).

Data 202 that is associated with a virtual process that one or more users are completing may be provided to a rule search component 220. The rule search component 220 may be a computing component that is configured to search the rule database 225 to identify and retrieve rules 222 that are relevant to the virtual process. For example, the identifying may be based on a semantic similarity search involving the embeddings of the rules and one or more tokens within the data 202. For example, embedding representations of the data 202 may be created, and a semantic similarity comparison may be performed to identify the rules 222 that are most semantically similar to the data 202. This comparison may be performed by calculating the dot product between two embedding vectors, determining the cosine similarity, Jaccard similarity, Euclidean distance, or Levenshtein distance between two embedding vectors, using other types of semantic similarity algorithms, or using other techniques for comparing two vectors as known in the art. Rules that are identified as relevant to the virtual process based on the data 202 may be provided as part of an input to generative model 200.

The data 202 may be provided to a knowledge graph search component 210. The knowledge graph search component 210 may be a computing component that is configured to search the knowledge graph database 215 to identify and retrieve knowledge graphs based on the data. In some embodiments, the knowledge graph search component 210 uses a graph query language to retrieve relevant knowledge graphs. Based on one or more tokens within the data 202, a query may be made using the graph query language, and one or more knowledge graphs 212 may be retrieved based on the query.

The query may be made by generating a prompt based on the data 202. For example, the prompt may be a natural language prompt generated based on populating a prompt template based on the data 202, or the prompt may be generated based on providing the data 202 as input to a generative machine learning model. In an example, the data for a virtual process involving software application development may indicate that Function D is required for the software application code. A natural language declarative query may be generated that requests knowledge graphs (or information therefrom) for virtual processes that involve Function D. In another example, the data for a virtual process involving electronic tax form completion may indicate that the user completing the form is highly experienced. A natural language declarative query may be generated that requests knowledge graphs (or information therefrom) for virtual processes that involve highly experienced users.

Based on the query, one or more knowledge graphs 212 may be identified, and an input may be provided to the generative model 200 based on the knowledge graphs 212. In certain embodiments, the information contained within the knowledge graphs 212 may be used to generate a natural language prompt to provide to the generative model 200. For example, information that is returned by the graph query language may be used to populate a prompt template or provided to a generative machine learning model to generate a prompt. The prompt may be provided as input to the generative model 200. The input may describe one or more historical virtual process instances that are represented by the knowledge graphs 212.

In some embodiments, embeddings of knowledge graphs and/or nodes within the knowledge graphs may be created. Thus, knowledge graphs that are relevant to the virtual process may be identified based on semantic similarity comparisons involving the embedding representations of the graphs/nodes and embedding representations of the data 202.

Certain embodiments provide that a knowledge graph representation of the virtual process that corresponds to the data 202 may be created. The knowledge graph may be added to the knowledge graph database 215. In some embodiments, this knowledge graph may be used to retrieve the retrieved knowledge graphs 212. For example, an embedding representation of the knowledge graph may be created and compared to embedding representations of knowledge graphs within the knowledge graph database to identify knowledge graphs that are most semantically similar. Alternately, knowledge graphs that are otherwise similar to the knowledge graph may otherwise be retrieved (e.g., based on matches between the nodes of the knowledge graphs). By updating the knowledge graph database 215 with knowledge graphs of virtual processes that users complete, embodiments disclosed herein allow for updating the virtual process evaluation system without retraining a machine learning model based on newly completed virtual processes. For example, existing machine learning techniques may require continuous retraining based on newly completed virtual processes to remain accurate and up to date. However, techniques disclosed herein may utilize the knowledge graph architecture disclosed herein instead of retraining. Thus, when the knowledge graph database 215 is updated, the virtual process evaluation system will be updated as well.

According to certain embodiments, knowledge graphs may be retrieved based on the retrieved rules 222. For example, the retrieved rules 222 and the data 202 may be provided as part of an input to a machine learning model such as generative model 200. Based on this input, the machine learning model may generate an output. The output may, for example, indicate whether a rule is satisfied. For instance, if the virtual process lacks a field that a rule 222 indicates is required, the output may indicate that the rule 222 is not satisfied. As another example, if a rule 222 indicates that complexity of software code increases as the number of a particular type of function increases, the output may indicate that the software code is highly complex if several instances of the function are found in the code. Knowledge graphs including the historical knowledge graphs may be created based on the output (e.g., a given knowledge graph may include nodes that indicate whether or not rules have been complied with, complexity that is calculated based on rules, and/or the like). The knowledge graphs may thus be retrieved based on the rules 222. For example, if the virtual process contains Error A, knowledge graphs that correspond to virtual processes that contain Error A may be retrieved.

An input based on the data 202, the retrieved knowledge graphs 212, and/or the retrieved rules 222 may be provided to the generative machine learning model 200. The generative machine learning model 200 may be generally any type of generative machine learning model such as a large language model, other type of transformer model, neural network, or other type of machine learning model capable of generating text content. The input may comprise a natural language prompt that is generated based on the data 202, the retrieved knowledge graphs 212, and/or the retrieved rules 222. For example, the data 202, the retrieved knowledge graphs 212, and/or the retrieved rules 222 may be used to populate a prompt template. As another example, the data 202, the retrieved knowledge graphs 212, and/or the retrieved rules 222 may be provided to a machine learning model (e.g., another generative machine learning model) that is trained to generate natural language prompts based on data, retrieved knowledge graphs, and/or retrieved rules. The prompt may describe the relevant historical virtual process instances and the relevant retrieved rules in a way that enables the generative model 200 to process the instances and rules and generate an evaluation 230 of a virtual process based on data 202 corresponding to the virtual process. The prompt may thus provide the generative model 200 with relevant context for accurately evaluating the virtual process, which may eliminate the need for training and/or fine tuning the generative model 200 for the particular purpose, domain, or software application to which the virtual process relates.

In an example, the input may describe the historical virtual processes that are relevant to the virtual process being evaluated. The description may include a description of the time taken to complete the relevant virtual processes based on the order of steps taken. For example, the relevant virtual processes may be virtual processes that are in a similar state of completion (e.g., similar fields completed, similar user experience level, and/or the like) as the virtual process being evaluated. Completing the remaining steps of the virtual process in a first order may have taken a greater amount of time than completing the steps in a second order (e.g., as indicated by data within knowledge graphs that correspond to the orders). Thus, the input may indicate that the second order is more efficient than the first. The fastest/most efficient order may be impacted by the data 202 as well, and also the retrieved rules 222. For example, a first subset of relevant virtual processes may have been completed fastest using a first order or steps, while a second subset of relevant virtual processes may have been completed fastest using a second order of steps. The generative machine learning model 200 may generate a prediction indicating the fastest order of steps based on whether the virtual process being evaluated is more similar to the first subset or the second subset (e.g., based on the data 202 and the rules 222).

The evaluation 230 may generally comprise any type of evaluation of a virtual process that can be generated by the generative model 200. For example, the evaluation 230 may comprise an indication of a level of completion (e.g., a completion percentage) of the virtual process. The level of completion may be not be directly proportional to the number of parts of the virtual process that have been completed, since some parts may require more time and/or work to complete. The evaluation 230 may comprise a recommended order of steps to complete the virtual process more efficiently, an indication of a level of quality of the virtual process, and/or the like. The evaluation 230 may comprise a predicted time required to complete the virtual process. The evaluation 230 may be generated based on the information from the retrieved knowledge graphs 212, the retrieved rules 222, and/or the data 202 associated with the virtual process being evaluated. The information from the retrieved knowledge graphs 212 may provide context that is relevant to the evaluation 230 (e.g., context as to how long it takes to complete virtual processes that are in a similar state of completion, context as to what orders of step completion results in the quickest completion of for similar virtual processes, and or the like). The rules 222 may provide additional context (e.g., the amount of errors present in this virtual process compared to the historical virtual processes and/or the level of complexity of this virtual process compared to the historical virtual processes). Also, the data 202 may provide further context (e.g., the similarity of the virtual process being evaluated to the historical virtual processes). As discussed above, this context may enable generative model 200 to accurately evaluate the virtual process, which may eliminate the need for particular training and/or fine tuning the generative model 200.

One or more input prompts (e.g., a natural language query used to retrieve knowledge graphs and/or the input prompts provided to the generative machine learning model 200) may be validated to prevent errors such as hallucinations. The validation may be rule-based (e.g., checking whether the prompt complies with a set of rules, such as rules that define valid ranges, valid formats, and/or the like). The validation may involve machine learning-based techniques. For example, a machine learning model may be trained to detect errors in prompts. In some embodiments, few-shot examples may be provided to a machine learning model to enable the machine learning model to detect errors in prompts. The few-shot examples may comprise labeled examples of prompts that contain errors and labeled examples of prompts that do not contain errors. Validation may also be performed for the evaluation 230 (e.g., to detect errors, such as hallucinations, in the evaluation 230).

### Example of a Knowledge Graph

FIG. 3 depicts an example of a knowledge graph 300 according to certain embodiments.

As shown in FIG. 3, the knowledge graph 300 represents a knowledge graph for a virtual process that comprises completing an electronic form. The knowledge graph 300 includes a document ID 301, an identifier that may be used to identify the type of the form being completed. This identifier may be used to identify knowledge graphs that are relevant to a particular virtual process. For example, if a user is completing a W2 form for an individual, an identifier may correspond to W2 forms and the identifier may be used to identify knowledge graphs that involve W2 forms.

The knowledge graph 300 also includes a user experience level 313. The user experience level may be based on the number of virtual processes a user has completed, the amount of time the user has worked with virtual processes, the user's level of proficiency in completing virtual processes, and/or the like. The user experience level 313 may be used to identify knowledge graphs that are relevant to a particular virtual process. For example, if a user completing a virtual process has a high level of experience, knowledge graphs that involve users with a high level of experience may be identified as relevant to the virtual process being completed.

The knowledge graph 300 also includes a complexity level 315. The complexity level 315 may be based on the number and/or type of fields/items in a virtual process, and/or the like. For example, rules may be used to determine the complexity of a form based on the fields present in the form and/or based on data provided by a user (e.g., an entry into one field of the form may make another field more complicated to complete). The complexity level 315 may be used to identify knowledge graphs that are relevant to a particular virtual process. For example, if a given virtual process that is being completed has a high level of complexity, knowledge graphs that involve virtual processes with a high level of complexity may be identified as relevant to the given virtual process.

The knowledge graph 300 also includes stages 302A and 302B. Stage 302A may represent a first stage in a user's completion of a virtual process, and stage 302B may represent a second stage in the user's completion of the virtual process. As indicated by the knowledge graph 300, stage 302A represents a stage in completion where an error 304 is present (e.g., based on a rule that indicates an error in the form) and there is a missing field 306. The time taken 308A to reach this stage of completion may also be represented by the knowledge graph 300. At stage 302B, the error 304 is still present in the form, but the missing field 306 has been completed. Time taken 308B may indicate the time taken to complete the missing field (e.g., time taken 308B may be equivalent to time taken 308A plus the amount of time required to complete the missing field). Knowledge graphs that are relevant to a particular virtual process may be retrieved based on the stages within the knowledge graphs. For example, if the virtual process being evaluated contains a given error and a given missing field, knowledge graphs that involve the particular error and the particular missing field may be retrieved.

### Example Operations Related to Automated Virtual Process Completion Assistance

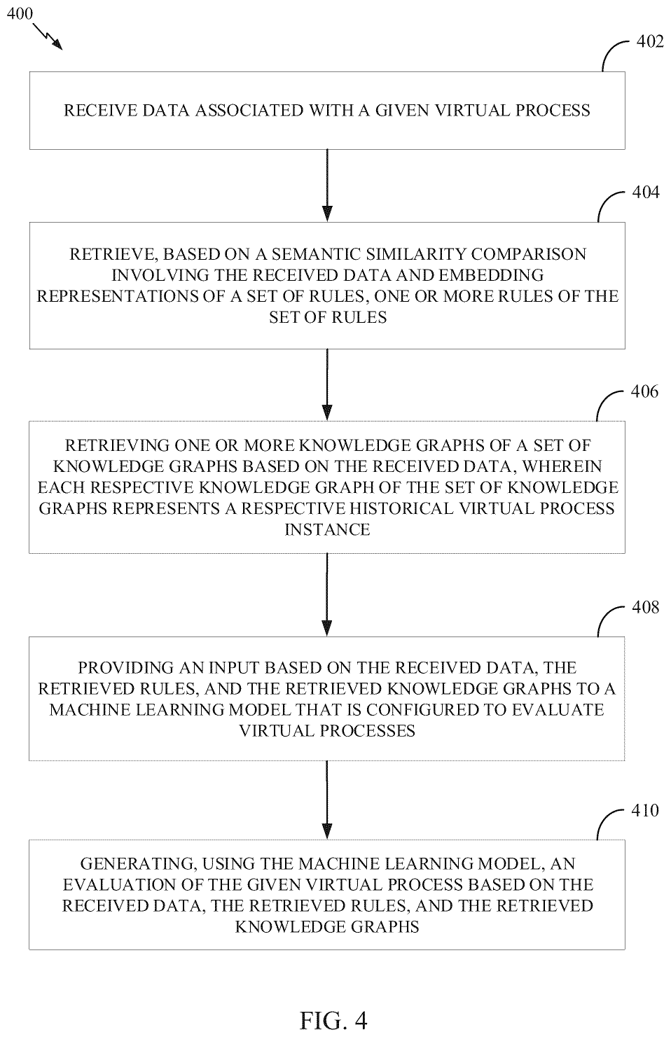

FIG. 4 depicts example operations 400 related to automated virtual process completion assistance. For example, operations 400 may be performed by one or more of the components described with respect to FIG. 1 and FIG. 2.

Operations 400 begin at step 402 with receiving data associated with a given virtual process. In some embodiments, the virtual process comprises an electronic form, wherein a generated evaluation for the virtual process comprises a recommended order for completing fields of the form. In some embodiments, the generated evaluation further comprises one or more of a predicted amount of progress in completing the form or a predicted time required to complete the form.

Operations 400 continue at step 404 with retrieving, based on a semantic similarity comparison involving the received data and embedding representations of a set of rules, one or more rules of the set of rules. In certain embodiments, the embedding representations of the set of rules are created based on providing multiple rules as input to an embedding model, wherein the semantic similarity comparison further involves embedding representations of one or more tokens within the received data.

Operations 400 continue at step 406 with retrieving one or more knowledge graphs of a set of knowledge graphs based on the received data, wherein each respective knowledge graph of the set of knowledge graphs represents a respective historical virtual process instance. In certain embodiments, the one or more knowledge graphs are retrieved based on using a graph query language to identify the one or more knowledge graphs based on tokens within the received data. In some embodiments, the one or more knowledge graphs are retrieved based on a semantic similarity comparison involving the received data and embedding representations of a respective knowledge graph. Certain embodiments provide that a particular knowledge graph of the one or more knowledge graphs is converted into a natural language description of a particular historical virtual process instance represented by the particular knowledge graph. Some embodiments provide that the evaluation is generated based on providing the natural language description as input to the machine learning model.

Operations 400 continue at step 408 with providing an input based on the received data, the retrieved rules, and the retrieved knowledge graphs to a machine learning model that is configured to evaluate virtual processes.

Operations 400 continue at step 410 with generating, using the machine learning model, an evaluation of the given virtual process based on the received data, the retrieved rules, and the retrieved knowledge graphs.

According to some embodiments, a knowledge graph representation of the given virtual process is created, wherein the one or more knowledge graphs of the set of knowledge graphs are retrieved based on the knowledge graph representation of the given virtual process. Certain embodiments provide that the knowledge graph representation of the given virtual process is added to the set of knowledge graphs.

### Example of a Processing System for Automated Virtual Process Completion Assistance

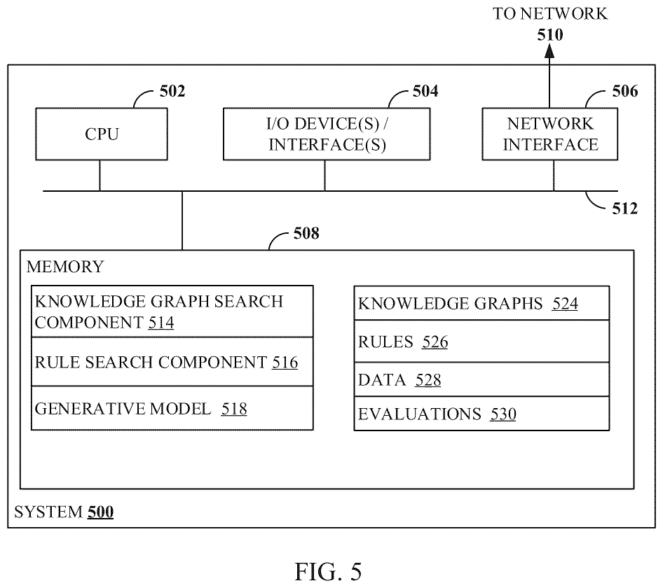

FIG. 5 illustrates an example system 500 with which embodiments of the present disclosure may be implemented. For example, system 500 may be configured to perform operations 400 of FIG. 4 and/or to implement one or more components as in FIG. 1 or FIG. 2.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes knowledge graph search component 514, rule search component 516, and generative model 518. Knowledge graph search component 514 may be representative of knowledge graph search component 210 of FIG. 2. In some embodiments, rule search component 516 may be representative of rule search component 220 of FIG. 2. Generative model 518 may be representative of generative model 200 of FIG. 2.

Memory 508 further comprises knowledge graphs 524, which may correspond to knowledge graphs 212 of FIG. 2 or knowledge graph 300 of FIG. 3. Memory 508 further comprises rules 526 which may correspond to rules 222 of FIG. 2. Memory 508 further comprises data 528, which may include data 202 of FIG. 2. Memory 508 further comprises evaluation 530, which may correspond to evaluation 230 of FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automatic virtual process completion assistance, comprising:
receiving data associated with a given virtual process;
retrieving, based on a semantic similarity comparison involving the received data and embedding representations of a set of rules, one or more rules of the set of rules;
retrieving one or more knowledge graphs of a set of knowledge graphs based on the received data, wherein each respective knowledge graph of the set of knowledge graphs represents a respective historical virtual process instance;
providing an input based on the received data, the retrieved rules, and the retrieved knowledge graphs to a machine learning model that is configured to evaluate virtual processes; and
generating, using the machine learning model, an evaluation of the given virtual process based on the received data, the retrieved rules, and the retrieved knowledge graphs.

2. The method of claim 1, wherein the one or more knowledge graphs are retrieved based on using a graph query language to identify the one or more knowledge graphs based on tokens within the received data.

3. The method of claim 1, wherein the one or more knowledge graphs are retrieved based on a semantic similarity comparison involving the received data and embedding representations of a respective knowledge graph.

4. The method of claim 1, wherein a particular knowledge graph of the one or more knowledge graphs is converted into a natural language description of a particular historical virtual process instance represented by the particular knowledge graph.

5. The method of claim 4, wherein the evaluation is generated based on providing the natural language description as input to the machine learning model.

6. The method of claim 1, further comprising creating a knowledge graph representation of the given virtual process, wherein the one or more knowledge graphs of the set of knowledge graphs are retrieved based on the knowledge graph representation of the given virtual process.

7. The method of claim 6, further comprising adding the knowledge graph representation of the given virtual process to the set of knowledge graphs.

8. The method of claim 1, wherein the virtual process comprises an electronic form, wherein the generated evaluation comprises a recommended order for completing fields of the form.

9. The method of claim 8, wherein the generated evaluation further comprises one or more of a predicted amount of progress in completing the form or a predicted time required to complete the form.

10. The method of claim 1, wherein the embedding representations of the set of rules are created based on providing multiple rules as input to an embedding model, wherein the semantic similarity comparison further involves embedding representations of one or more tokens within the received data.

11. A system for automatic virtual process completion assistance, comprising:
one or more processors; and
a memory comprising instructions that, when executed by the one or more processors, cause the system to:
receive data associated with a given virtual process;
retrieve, based on a semantic similarity comparison involving the received data and embedding representations of a set of rules, one or more rules of the set of rules;
retrieve one or more knowledge graphs of a set of knowledge graphs based on the received data, wherein each respective knowledge graph of the set of knowledge graphs represents a respective historical virtual process instance;
provide an input based on the received data, the retrieved rules, and the retrieved knowledge graphs to a machine learning model that is configured to evaluate virtual processes; and
generate, using the machine learning model, an evaluation of the given virtual process based on the received data, the retrieved rules, and the retrieved knowledge graphs.

12. The system of claim 11, wherein the one or more knowledge graphs are retrieved based on using a graph query language to identify the one or more knowledge graphs based on tokens within the received data.

13. The system of claim 11, wherein the one or more knowledge graphs are retrieved based on a semantic similarity comparison involving the received data and embedding representations of a respective knowledge graph.

14. The system of claim 11, wherein a particular knowledge graph of the one or more knowledge graphs is converted into a natural language description of a particular historical virtual process instance represented by the particular knowledge graph.

15. The system of claim 14, wherein the evaluation is generated based on providing the natural language description as input to the machine learning model.

16. The system of claim 11, wherein the instructions further cause the system to create a knowledge graph representation of the given virtual process, wherein the one or more knowledge graphs of the set of knowledge graphs are retrieved based on the knowledge graph representation of the given virtual process.

17. The system of claim 16, wherein the instructions further cause the system to add the knowledge graph representation of the given virtual process to the set of knowledge graphs.

18. The system of claim 11, wherein the virtual process comprises an electronic form, wherein the generated evaluation comprises a recommended order for completing fields of the form.

19. The system of claim 18, wherein the generated evaluation further comprises one or more of a predicted amount of progress in completing the form or a predicted time required to complete the form.

20. The system of claim 11, wherein the embedding representations of the set of rules are created based on providing multiple rules as input to an embedding model, wherein the semantic similarity comparison further involves embedding representations of one or more tokens within the received data.
